(19) United States
(12) Patent Application Publication
(10) Pub. No.: US 2019/0056044 A1
(43) Pub. Date: Feb. 21, 2019

(54) ELASTIC BODY FOR CLOSURE, AIR CONDITIONING DEVICE, AND CLOSURE METHOD

(71) Applicant: MITSUBISHI ELECTRIC CORPORATION, Chiyoda-ku, Tokyo (JP)

(72) Inventors: Kenichi HASHIZUME, Tokyo (JP); Tomohiko ISHIZUKA, Tokyo (JP)

(73) Assignee: MITSUBISHI ELECTRIC CORPORATION, Chiyoda-ku, Tokyo (JP)

(21) Appl. No.: 15/770,914

(22) PCT Filed: May 26, 2016
(86) PCT No.: PCT/JP2016/065623

§ 371 Date: Apr. 25, 2018

(30) Foreign Application Priority Data
Dec. 3, 2015 (JP) 2015-236397

(51) Int. Cl. F16L 5/10; B60H 1/00; B60H 1/32; F24F 1/02; B61D 27/00

(52) U.S. Cl. CPC F16L 5/10; B60H 1/00264; B60H 1/00371; B60H 1/3226; B60H 2001/00635; B60H 1/00571; B60H 1/3229; F24F 1/02; B61D 27/0018; B60H 1/00521

(57) ABSTRACT

A rubber body as an elastic body for closure closes a gap between a partition plate in which a through-hole is formed and refrigeration piping inserted through the through-hole. The rubber body for closure includes a pressurized insertion receiving portion having formed therein an opening into which the refrigeration piping is pressed and inserted, the pressurized insertion receiving portion elastically pressing and contacting in a liquid-tight manner an external surface of the refrigeration piping; a fitting portion fitted in a liquid-tight manner the peripheral edge portion of the through-hole in a state in which an inner circumferential surface of the through-hole is elastically pressed; and a displacement allowance portion that closes a gap between the pressurized insertion receiving portion and the fitting portion, and to allow a relative displacement of the pressurized insertion receiving portion and the fitting portion in a direction parallel to the partition plate.

### TECHNICAL FIELD

The present disclosure relates to an elastic body for closure, an air conditioning device and a closure method.

### BACKGROUND ART

An air conditioning device that air-conditions inside a room includes a casing and a refrigeration cycle device housed in the casing. The refrigeration cycle device includes a compressor, a condenser, an evaporator, an expander, a gas-liquid separator and refrigeration piping for connecting these devices.

To increase a thermal efficiency of the refrigeration cycle device, the inside of the casing is partitioned into a plurality of accommodation chambers by a partition plate. Among the components of the refrigeration cycle device, some of the components including the condenser are disposed in one accommodation chamber. The remaining components including the evaporator are disposed in another accommodation chamber.

The refrigeration piping penetrates the partition plate and is routed from one accommodation chamber to another accommodation chamber. When inflow of rainwater is allowed for one accommodation chamber and prevention of inflow of rainwater is required for another accommodation chamber, water-tightness is required for a portion of the partition plate penetrated by the refrigeration piping (hereinafter, referred to as a piping penetration portion).

Patent Literature 1 discloses a technique that uses a rubber body for closure to close a piping penetration portion in an air conditioning device in a watertight manner in order to meet such requirements.

### CITATION LIST

### Patent Literature

Patent Literature 1: Unexamined Japanese Patent Application Kokai Publication No. H05-147432

### SUMMARY OF INVENTION

### Technical Problem

The technique of Patent Literature 1 requires a process in which a support member supporting the rubber body for closure mentioned above is welded to a partition plate beforehand to attach the rubber body for closure to a piping penetration portion.

In addition, the rubber body for closure of Patent Literature 1 does not have a structure that allows misalignment between the center axis of the refrigeration piping and that of the through-hole formed in the partition plate. Therefore, when the two axes are misaligned, a process for correcting the misalignment is essential prior to the attachment of the rubber body for closure.

Therefore, the technique of Patent Literature 1 requires time and efforts for the attachment of the rubber body for closure. This hinders efficient manufacturing of an air conditioning device.

An objective of the present disclosure is to provide an elastic body for closure that can be easily installed and a closure method using the same. Another objective of the present disclosure is to provide an air conditioning device that can be efficiently manufactured.

### Solution to Problem

In order to achieve the above-mentioned objectives, an elastic body for closure of the present disclosure is an elastic body for closure for closing a gap between a plate-like body in which a through-hole is formed and a shaft that is inserted in the through-hole, including:

a pressurized insertion receiving portion having formed therein an opening into which the shaft is pressed and inserted, to elastically press and contact liquid-tightly against an external surface of the shaft that is pressed and inserted in the opening;

a fitting portion to fit liquid-tightly a peripheral edge portion of the through-hole in the plate-like body in a state elastically pressing against an inner circumferential surface of the through-hole; and

a displacement allowance portion to close a gap between the pressurized insertion receiving portion and the fitting portion, and allow a relative displacement of the pressurized insertion receiving portion and the fitting portion in a direction parallel to the plate-like body, by elastic deformation.

The fitting portion includes an external cylinder portion fitted in the through-hole, the displacement allowance portion includes an inner cylinder portion that is disposed inward in a radial direction of the external cylinder portion and a base coupled to the inner cylinder portion and the external cylinder portion, and a thickness of the inner cylinder portion reduces as the inner cylinder portion increases in distance from the base.

### Advantageous Effects of Invention

According to the elastic body for closure of the present disclosure, as the fitting portion fits against the peripheral edge portion of the through-hole, use of the support member for supporting the elastic body for closure is not required. In addition, the displacement allowance portion allows the relative displacement between the pressurized insertion receiving portion and the fitting portion. Thus, even when the center axis of the shaft and the center axis of the through-hole are misaligned, the process for correcting the misalignment can be omitted. Therefore, the elastic body for closure of the present disclosure can be easily attached.

Use of the elastic body for closure that can be easily attached enables efficient manufacturing of the air conditioning device.

### BRIEF DESCRIPTION OF DRAWINGS

FIG. 1 is a cross-sectional perspective view illustrating a mode of use of an elastic body for closure according to an embodiment;

FIG. 2 is a perspective view illustrating the mode of use of the elastic body for closure according to the embodiment;

FIG. 3 is a perspective view of the elastic body for closure according to the embodiment;

FIG. 4 is a cross section illustrating the mode of use of the elastic body for closure according to the embodiment;

FIG. 5 is an enlarged cross section around a fitting portion of the elastic body for closure according to the embodiment;

FIG. 6 is an enlarged cross section around a fitting portion of an elastic body for closure according to another embodiment;

FIG. 7 is an enlarged cross section of a pressurized insertion receiving portion of the elastic body for closure according to the embodiment;

FIG. 8 is a perspective view illustrating another mode of use of the elastic body for closure according to the embodiment;

FIG. 9 is a cross section illustrating another mode of use of the elastic body for closure according to the embodiment;

FIG. 10 is a perspective view illustrating yet another mode of use of the elastic body for closure according to the embodiment;

FIG. 11 is a cross section illustrating yet another mode of use of the elastic body for closure according to the embodiment;

FIG. 12 is a perspective view illustrating yet another mode of use of the elastic body for closure according to the embodiment;

FIG. 13 is a cross section illustrating yet another mode of use of the elastic body for closure according to the embodiment; and

FIG. 14 is a partial sectional plan view of an air conditioning device for a vehicle according to the embodiment.

### DESCRIPTION OF EMBODIMENTS

Hereinafter, with reference to the drawings, an air conditioning device for a vehicle and an elastic body for closure according to one embodiment of the present disclosure are described. In the drawings, components that are the same or equivalent are assigned the same reference signs.

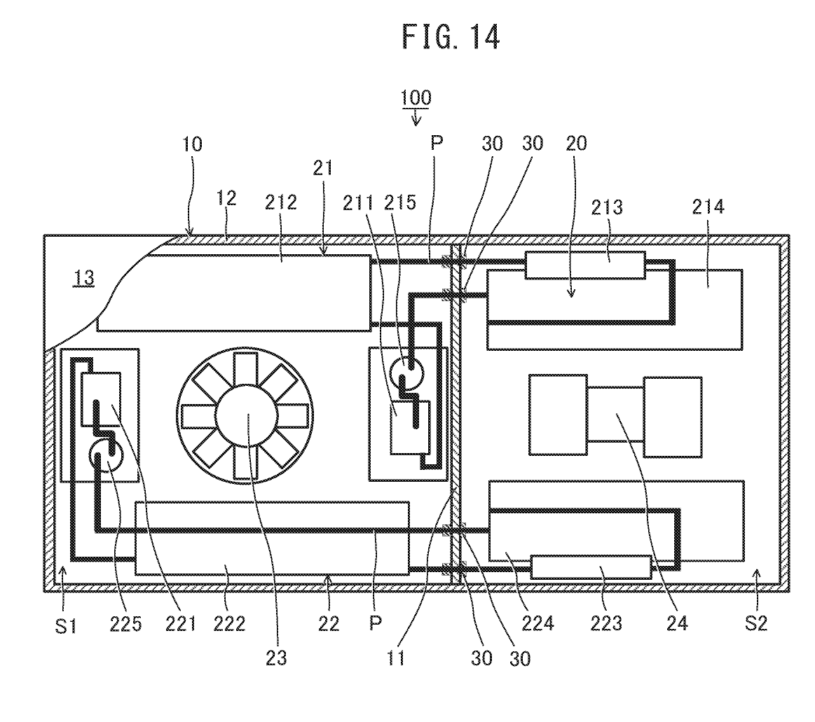

As illustrated in FIG. 14, an air conditioning device for a vehicle 100 according to the present embodiment includes a housing 10 defining spaces therein, a partition plate 11 functioning as a plate-like body that partitions the inside of the housing 10 into two accommodation chambers, an air conditioning device 20 including refrigeration piping P as a shaft penetrating the partition plate 11, and a rubber body 30 for closure as an elastic body for closure that closes a portion of the partition plate 11 penetrated therethrough by the refrigeration piping P. In addition, to clarify a structure of the refrigeration piping P, FIG. 14 illustrates the colored refrigeration piping P.

The housing 10 is installed on the roof of the railroad vehicle, and includes a box-like base frame 12 whose upper portion is open and is rectangular-shaped and long in the traveling direction of the railway vehicle (lateral direction in FIG. 14), and a cover 13 closing the upper portion of an opening of the base frame 12. In order to facilitate understanding, FIG. 14 illustrates only a portion of the cover 13.

The partition plate 11 partitions an internal space defined by the base frame 12 and the cover 13 into an outdoor unit accommodation chamber S1 and an indoor unit accommodation chamber S2.

In this way, an objective of partitioning the inside of the housing 10 is to thermally isolate a condenser and an evaporator of the refrigeration cycle device included in the air conditioning device 20 by disposing one of the condenser and the evaporator in the outdoor unit accommodation chamber S1 and disposing the other in the indoor unit accommodation chamber S2 to increase a thermal efficiency of the refrigeration cycle device.

The air conditioning device 20 is housed in the housing 10. The air conditioning device 20 includes the two refrigeration cycle devices 21 and 22, an outdoor blower 23, and an indoor blower 24. The two refrigeration cycle devices 21 and 22 include the refrigeration piping P distributing a refrigerant forming two refrigeration cycles. The outdoor blower 23 releases air outside, a temperature of the air being adjusted by one of the condenser and the evaporator of the refrigeration cycle devices 21 and 22. The indoor blower 24 sends air, whose temperature is adjusted by the other of the condenser or the evaporator, to each room.

The one refrigeration cycle device 21 includes a compressor 211, an outdoor heat exchanger 212, an expander 213, an indoor heat exchanger 214 and a gas-liquid separator 215 that are mutually connected by the refrigeration piping P.

The refrigeration cycle device 22 similarly includes a compressor 221, an outdoor heat exchanger 222, an expander 223, an indoor heat exchanger 224 and a gas-liquid separator 225 that are mutually connected by refrigeration piping P different from the refrigeration piping included in the refrigeration cycle device 21.

Among the pair of the outdoor heat exchangers 212 and 222 and the pair of the indoor heat exchangers 214 and 224, one pair may be evaporators and the other pair may be condensers, and vice versa. Each of the expanders 213 and 223 includes an expansion valve or a capillary tube.

The compressors 211 and 221, the outdoor heat exchangers 212 and 222, the gas-liquid separators 215 and 225 and the outdoor blower 23 are disposed in the outdoor unit accommodation chamber S1.

The expanders 213 and 223, the indoor heat exchangers 214 and 224 and the indoor blower 24 are disposed in the indoor unit accommodation chamber S2.

Hereinafter, functions of the air conditioning device 100 for vehicles are described in reference to, for example, a case in which the passenger compartment of a railroad vehicle is cooled. The functions of the two refrigeration cycle devices 21 and 22 are similar. Thus, the functions of one of the refrigeration cycle device 21 are typically described.

The compressor 211 compresses the refrigerant. The compressed refrigerant is sent to the outdoor heat exchanger 212 which is used as a condenser. The outdoor heat exchanger 212 liquefies the refrigerant by releasing heat to the environment. The air heated by the outdoor heat exchanger 212 is then released to the outside by the outdoor blower 23.

The refrigerant liquefied by the outdoor heat exchanger 212 is depressurized in the expander 213, and is sent to the indoor heat exchanger 214 as an evaporator. The indoor heat exchanger 214 vaporizes the refrigerant by absorbing heat from outside. The air cooled by the indoor heat exchanger 214 is then sent into the passenger compartment by the indoor blower 24.

The refrigerant vaporized in the indoor heat exchanger 214 is sent to the gas-liquid separator 215. The gas-liquid separator 215 separates the vaporized refrigerant from the liquid refrigerant not vaporized by the indoor heat exchanger 214 and sends only the gaseous refrigerant to the compressor 211. In the above-mentioned procedure, the refrigerant is cycled.

The air conditioning device 100 for vehicles is particularly characterized in that the rubber body 30 for closure is configured to enable attachment in a small number of steps. Hereinafter, the rubber body 30 for closure is described.

In the air conditioning device 100 for vehicles, the outdoor unit accommodation chamber S1 has a configuration in which rainwater can flow in. As the indoor unit accommodation chamber S2 communicates with the passenger compartment, the inflow of rainwater into the indoor unit accommodation chamber S2 has to be prevented. Therefore, water-tightness is required in each portion of the partition plate 11 penetrated therethrough by the refrigeration piping P.

Specifically, water-tightness is required in portions in which the partition plate 11 is, penetrated by: the refrigeration pipe P connecting the outdoor heat exchanger 212 and the expander 213, the refrigeration pipe P connecting the indoor heat exchanger 214 and the gas-liquid separator 215, the refrigeration pipe P connecting the outdoor heat exchanger 222 and the expander 223, and the refrigeration pipe P connecting the indoor heat exchanger 224 and the gas-liquid separator 225.

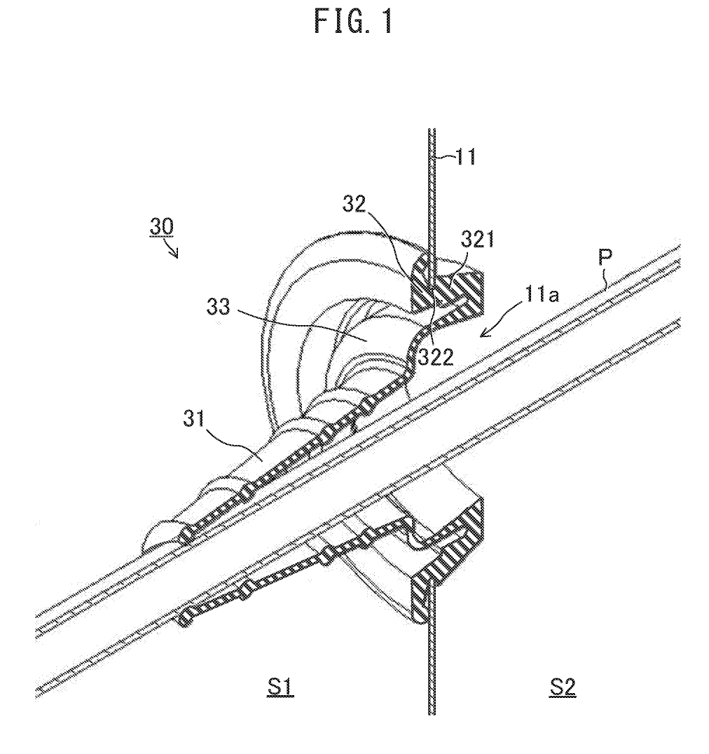

The rubber bodies 30 for closure water-tightly close each portion in which those refrigeration pipes P penetrating the partition plate 11. The configurations of each of the rubber bodies 30 for closure are similar. Therefore, with reference to FIGS. 1 through 13, the structure of one rubber body 30 for closure and the vicinity thereof is representatively described in detail as follows.

As illustrated in FIG. 1, a through-hole 11a is formed in the partition plate 11, and the refrigeration piping P is inserted through the through-hole 11a. The inner diameter of the through-hole 11a is larger than an outer diameter of the refrigeration piping P, and a gap is secured between the partition plate 11 and the refrigeration piping P. The rubber body 30 for closure water-tightly closes the gap.

The rubber body 30 for closure is formed of an elastic material, specifically integrally molded ethylene propylene diethylene rubber (EPDM). The whole material is elastic. In addition, other synthetic or natural rubber, and other resin can be used as the elastic material.

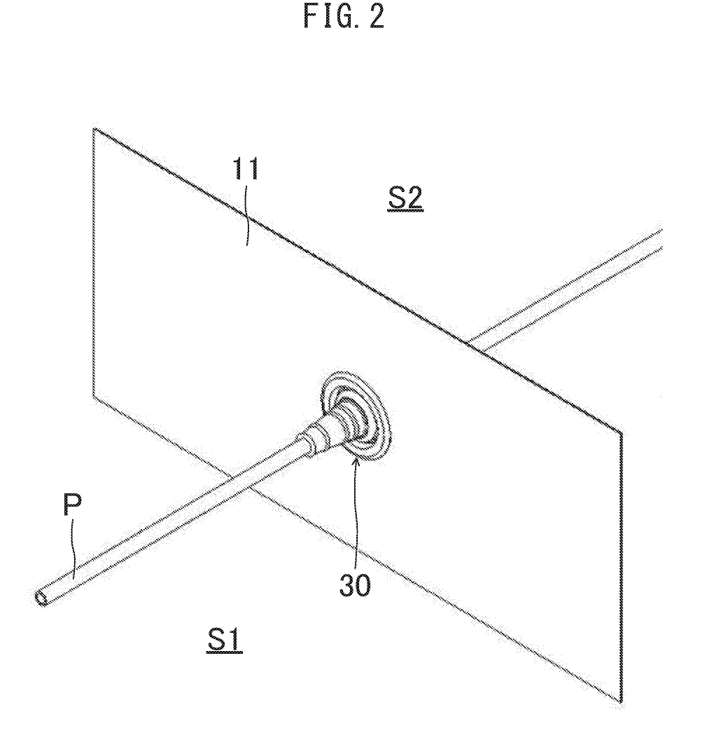

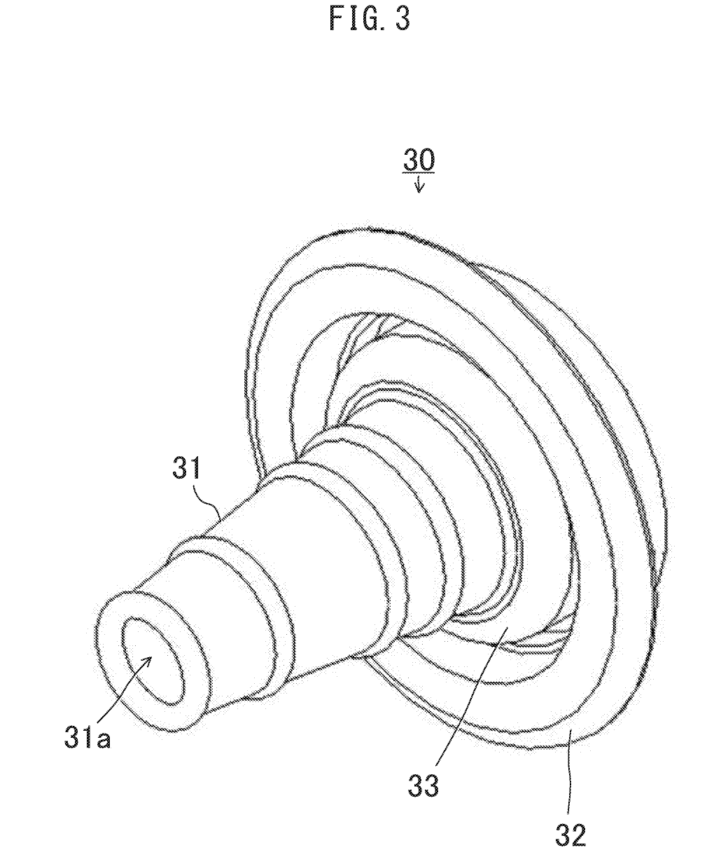

As illustrated in FIG. 2, the rubber body 30 for closure is used in a state in which the refrigeration piping P is pressed and inserted in the rubber body 30 for closure and the rubber body 30 for closure is fitted in the partition plate 11. Specifically, as illustrated in FIG. 3, the rubber body 30 for closure includes a pressurized insertion receiving portion 31, a fitting portion 32, and a displacement allowance portion 33. An opening 31a in which the refrigeration piping P is pressed and inserted is formed in the pressurized insertion receiving portion 31. The fitting portion 32 fits to a peripheral edge portion of the through-hole 11a in the partition plate 11. The displacement allowance portion 33 connects the pressurized insertion receiving portion 31 and the fitting portion 32.

As illustrated in FIG. 1, the fitting portion 32 includes an external cylinder portion 321 that fits in the through-hole 11a. The external cylinder portion 321 forms a cylinder having a height in an insertion direction along the through-hole 11a of the refrigeration piping P (hereinafter, referred to as the piping insertion direction). The refrigeration piping P pressed and inserted in the pressurized insertion receiving portion 31 penetrates the partition plate 11 by passing through the inside of the external cylinder portion 321. Here, being pressed and inserted means to be inserted while pressing and expanding open the opening 31a of the pressurized insertion receiving portion 31.

A groove 322 whose cross section is concave is formed over the entire periphery of the through-hole 11a at a position of the outer peripheral surface of the external cylinder portion 321 facing an inner circumferential surface of the through-hole 11a. The groove 322 and the peripheral edge portion of the through-hole 11a in the partition plate 11 are fitted together over the entire periphery.

In a free state of the external cylinder portion 321 in which no stress is applied to the external cylinder portion 321, the outer diameter of the external cylinder portion 321 is slightly larger than the inner diameter of the through-hole 11a. The external cylinder portion 321 is fitted in the through-hole 11a in a state of compression inward in the radial direction.

For this reason, a bottom surface of the groove 322 elastically presses an inner circumferential surface of the through-hole 11a by elastic repulsive force of the external cylinder portion 321. The external cylinder portion 321 is the part most thickly formed among the parts of the rubber body 30 for closure, and applies elastic repulsive force sufficient to secure water-tightness between the bottom surface of the groove 322 and the inner circumferential surface of the through-hole 11a. In this way, water-tightness is secured in a fitted portion between the fitting portion 32 and the partition plate 11.

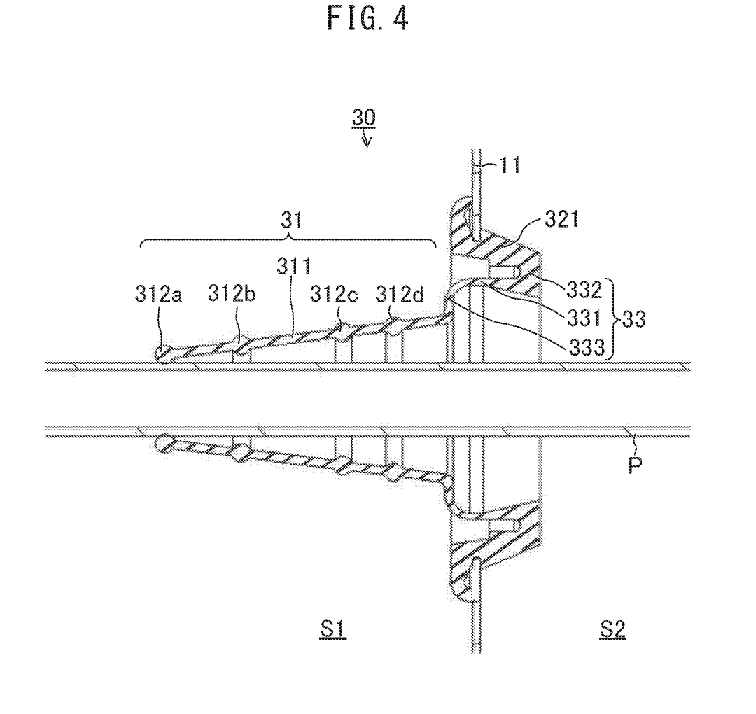

As illustrated in FIG. 4, the displacement allowance portion 33 includes an inner cylinder portion 331, a base 332 and a curved portion 333.

The inner cylinder portion 331 is disposed inward in the radial direction of the external cylinder portion 321 and forms a cylinder having a height in the above-mentioned piping insertion direction (in the horizontal direction in FIG. 4).

The base 332 is disposed in an end portion (right end in FIG. 4) of the rubber body 30 for closure in the above-mentioned piping insertion direction. Specifically, the base 332 is disposed in the indoor unit accommodation chamber S2. The base 332 connects the inner cylinder portion 331 and the external cylinder portion 321. Entry of rainwater from the base 332 and into the space between the pressurized insertion receiving portion 31 and the refrigeration piping P can be prevented, by use of the rubber body 30 for closure facing both of the outdoor unit accommodation chamber S1 into which rainwater can flow and the indoor unit accommodation chamber S2 in which an inflow of rainwater is to be prevented, such that this base 332 is disposed toward the indoor accommodation chamber S2 side.

The curved portion 333 is connected to an end of the inner cylinder portion 331 on the opposite side of the base 332 (left end in FIG. 4) with respect to a piping insertion direction, and has a shape that is curved to approach the refrigeration piping P.

The thickness of the inner cylinder portion 331 reduces as the inner cylinder portion 331 goes away from the base 332. The thickness of the curved portion 333 is equal to the thickness of the connection portion of the inner cylinder portion 331 with the curved portion 333. In this way, the thicknesses of the inner cylinder portion 331 and the curved portion 333 are formed smaller than that of the base 332, and easy and elastic displacement is enabled in a direction parallel to the partition plate 11 with respect to the base 332.

The pressurized insertion receiving portion 31 is disposed in the outdoor unit accommodation chamber S1. The pressurized insertion receiving portion 31 includes a tapered tubular portion 311 and a plurality of ring portions 312a through 312d formed along the tapered tubular portion 311.

The tapered tubular portion 311 forms a tube extending in the piping insertion direction, an end thereof is connected to the curved portion 333 in the piping insertion direction, and has a shape in the piping insertion direction that is continuously tapered as the tapered tubular portion 311 goes away from the curved portion 333.

Each of the ring portions 312a through 312d is formed by a local annular thickening of the tapered tubular portion over the entire periphery on the side thereof. The ring portions 312a through 312d are discretely distributed in the piping insertion direction. Inner diameters of the ring portions 312a through 312d are different from each other in response to the tapered tubular portion 311 having a tapered shape. In other words, the inner diameter of the ring portion 312d closest to the curved portion 333 is the largest, and the inner diameter of the ring portion 312a most distant from the curved portion 333 is the smallest.

The ring portion 312a most distant from the curved portion 333 is disposed in the piping insertion direction end of the tapered tubular portion 311. The refrigeration piping P is pressed and inserted in the ring portion 312a.

In a natural state of the ring portion 312a free of applied stress, the inner diameter of the ring portion 312a is slightly smaller than the outer diameter of the refrigeration piping P. The refrigeration piping P is pressed and inserted in a state in which the ring portion 312a is outwardly extended in the radial direction of the ring portion 312a. The ring portion 312a is pressed and contacted against the external surface of the refrigeration piping P. In this way, water-tightness between the pressurized insertion receiving portion 31 and the refrigeration piping P is secured. In the present specification, being pressed and contacted means to closely contact an object in a state of being pressed against the object.

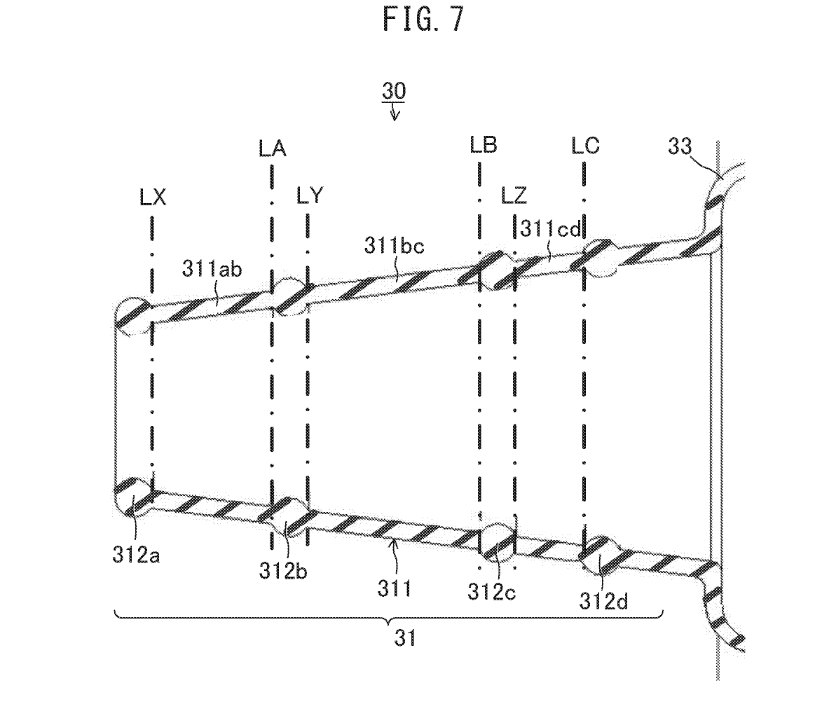

In addition, significance of the other ring portions 312b through 312d is described later using FIG. 7.

As understood from the above-mentioned description, the rubber body 30 for closure can be attached by using two processes, that is, a press-insertion process and a fitting process. In the press-insertion process, the pressurized insertion receiving portion 31 is elastically and liquid-tightly pressed and contacted against the external surface of the refrigeration piping P by pressing and inserting the refrigeration piping P in the opening 31a. In the fitting process, the fitting portion 32 is pushed in the through-hole 11a, and is water-tightly fitted into the peripheral edge portion of the through-hole 11a in a state in which the fitting portion 32 elastically presses the inner circumferential surface of the through-hole 11a. The order of performing the press-insertion process and the fitting process is freely selected. Any one of the processes may be performed first.

Because the fitting portion 32 fits in the peripheral edge portion of the through-hole 11a, a conventionally necessary support member is not required to be used for the fitting portion 32. Thus, a process of welding the support member to the partition plate 11 can be omitted. In addition, no threaded fasteners such as a bolt and crew are required to be used, and the labor of turning threaded fasteners is not required. In addition, the rubber body 30 for closure itself directly and water-tightly engages with the refrigeration piping P and the partition plate 11. Thus, no sealing material is required separately, and the labor of applying or laying the sealing material is not required.

In addition, formed thicknesses of the inner cylinder portion 331 and the curved portion 333 of the displacement allowance portion 33 are relatively small, and easy and elastic deformation is enabled. Thus, a relative displacement between the pressurized insertion receiving portion 31 and the fitting portion 32 in the direction parallel to the partition plate 11 is allowed by the displacement allowance portion 33. Therefore, when the center axis of the refrigeration piping P and the center axis of the through-hole 11a are misaligned, specifically when the two axes are skewed, or the two axes are parallel but there is a gap between the two axes, labor for correcting the misalignment can be omitted.

As a result, the rubber body 30 for closure can be easily attached. In this way, efficient manufacturing of the air conditioning device 100 for vehicles illustrated in FIG. 14 can be achieved by using the rubber body 30 for closure that can be easily attached.

In addition, the rubber body 30 for closure is integrally molded to form a single-unit component. Thus, problems of a closing member including combinations of a plurality of parts, that is, problems of occurrence of troubles due to defective parts having shape variation and/or problems of the time required for preparing a plurality of parts, can be avoided.

In addition, the following effects can be achieved by forming the inner cylinder portion 331 and the curved portion 333 relatively thinly to form a configuration in which the inner cylinder portion 331 and the curved portion 333 are elastically deformed preferentially.

In other words, when the center axis of the refrigeration piping P and the center axis of the through-hole 11a is misaligned, the inner cylinder portion 331 and the curved portion 333 are elastically deformed preferentially, enabling suppression of loads, due to the misalignment of the center axes, on the fitting portion 32 and the pressurized insertion receiving portion 31. The fitting portion 32 and the pressurized insertion receiving portion 31 are responsible for securing of water-tightness. Therefore, loss of water-tightness can be suppressed by suppressing the load that causes a distortion of the fitting portion 32 and the pressurized insertion receiving portion 31.

In addition, in the air conditioning device 100 for vehicles, even after the attachment of the rubber body 30 for closure, a case may occur in which a stress, due to vibration and inertial force generated during travel of the vehicle that increases the misalignment between the center axis of the refrigeration piping P and the center axis of the through-hole 11a, acts on the rubber body 30 for closure. Even, in that case, the displacement allowance portion 33 elastically deforms preferentially, and a fitting state of the fitting portion 32 and the partition plate 11 and a pressing and contacting state of the ring portion 312a to the refrigeration piping P are maintained. Therefore, the loss of the water-tightness between the refrigeration piping P and the partition plate 11 can be suppressed.

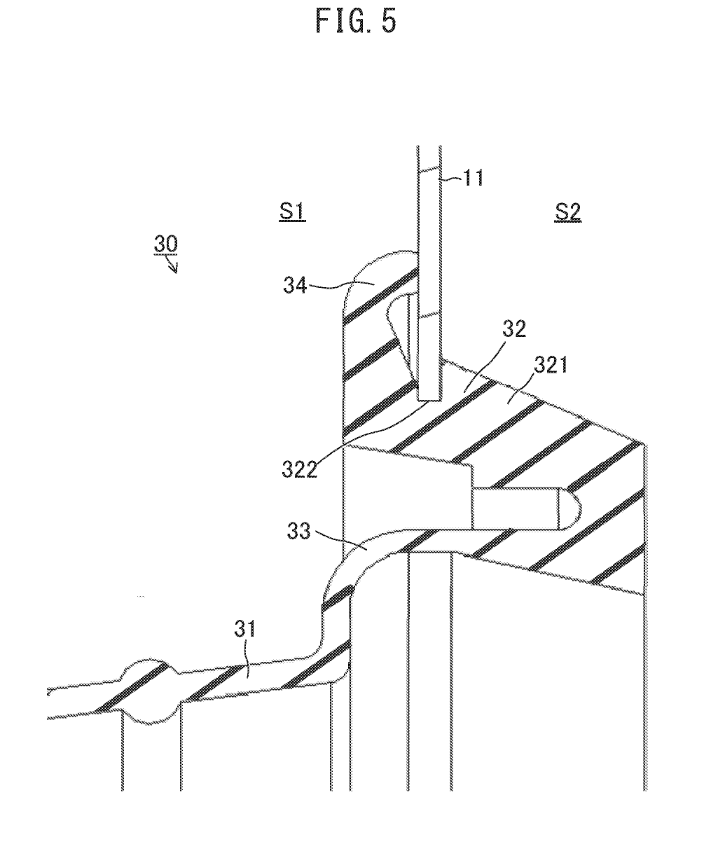

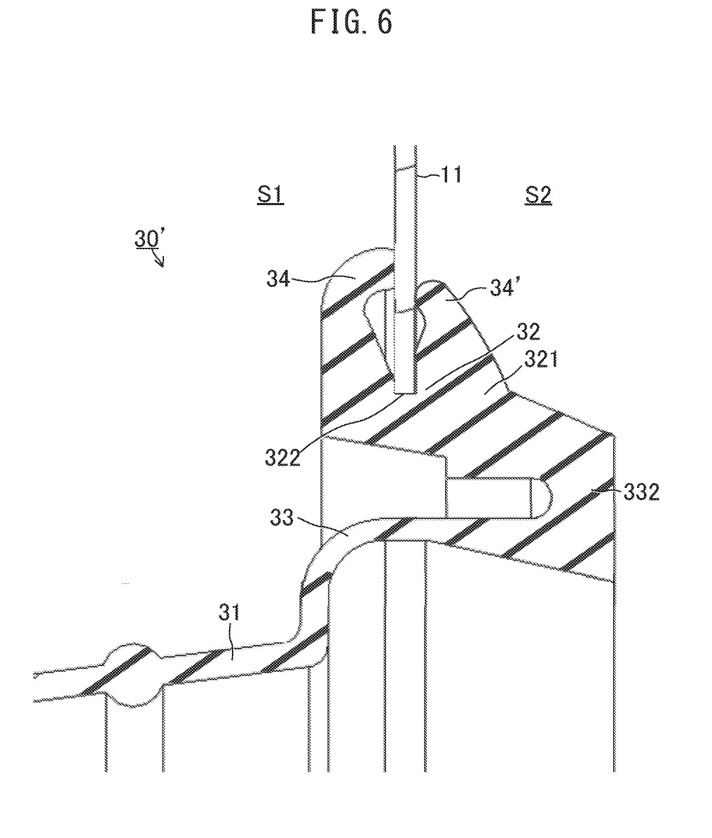

With reference to FIGS. 5 and 6, the detailed configuration of the rubber body 30 for closure is further described as follows.

As illustrated in FIG. 5, the rubber body 30 for closure further includes a lip portion 34 that extends in the outward radial direction of the through-hole 11a from an end of the external cylinder portion 321 of the fitting portion 32 on the pressurized insertion receiving portion 31 side with respect to the piping insertion direction, and that elastically contacts the partition plate 11.

The lip portion 34 elastically contacts a surface of the partition plate 11 on the pressurized insertion receiving portion 31 side to surround the through-hole 11a over the entire periphery. In this way, penetration of rainwater, moisture, and the like to the fitting portion 32 can be suppressed. Thus, the water-tightness between the partition plate 11 and the fitting portion 32 can be improved. In addition, the rubber body 30 for closure can stably set and slip can be prevented.

As illustrated in FIG. 6, a lip portion 34′ may further be installed that pinches the partition plate 11 together with the lip portion 34 from both sides in the piping insertion direction. The lip portion 34′ extends in the outward radial direction of the through-hole 11a from a position of the external cylinder portion 321 on the base 332 side rather than the partition plate 11 side with respect to the piping insertion direction, and elastically contacts the surface of the partition plate 11 on the base 332 side.

Similar to the lip portion 34, the lip portion 34′ also elastically contacts the partition plate 11 over the entire periphery so that the lip portion 34′ surrounds the through-hole 11a. In this way, the water-tightness between the fitting portion 32 and the partition plate 11 can be further improved and the rubber body 30 for closure can be set more stably.

With reference to FIGS. 7 through 11, significance of the ring portions other than the ring portion 312a as illustrated in FIG. 4, that is, the ring portions 312b through 312d, is described as follows.

As illustrated in FIG. 7, corresponding to the fact that the inner diameter of the tapered tubular portion 311 increases with approach to the displacement allowance portion 33, inner diameters of the ring portions 312a through 312d increase with approach to the displacement allowance portion 33. For a user to be able to select and use a ring portion of a desired size among the ring portions 312a through 312d, the tapered tubular portion 311 of the rubber body 30 for closure can be used by cutting along a cross section perpendicular to the piping insertion direction. Imaginary lines LA through LC and LX through LZ arranged in the piping insertion direction indicate the above-mentioned cross sections.

FIG. 4 illustrates a state in which the refrigeration piping P is pressed and inserted into the ring portion 312a that is smallest and most distant from the displacement allowance portion 33. In this case, cutting of the tapered tubular portion 311 is not required.

When refrigeration piping thicker than the refrigeration piping P illustrated in FIG. 4 is used, the tapered tubular portion 311 may be used by cutting, for example, at a position of the imaginary line LA of FIG. 7. The imaginary line LA passes through an end of the ring portion 312b on the opposite side of the displacement allowance portion 33 in the piping insertion direction. In this way, refrigeration piping having an outer diameter corresponding to the inner diameter of the ring portion 312b can be used.

When refrigeration piping of further thickness is used, the tapered tubular portion 311 may be similarly used by cutting at a position of the imaginary line LB or LC. The imaginary lines LB and LC pass through ends of the ring portions 312c and 312d, respectively, on the opposite side of the displacement allowance portion 33 in the piping insertion direction.

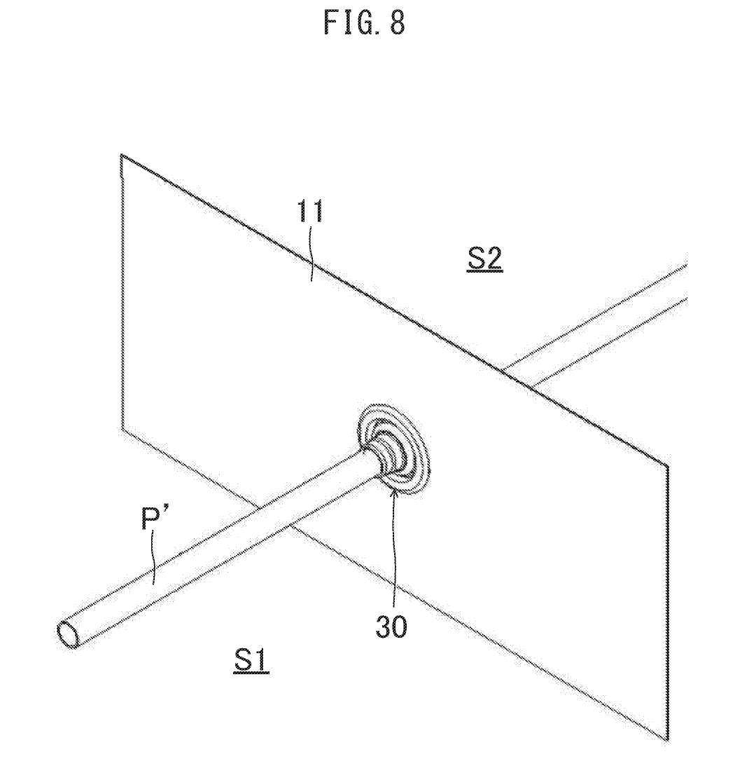

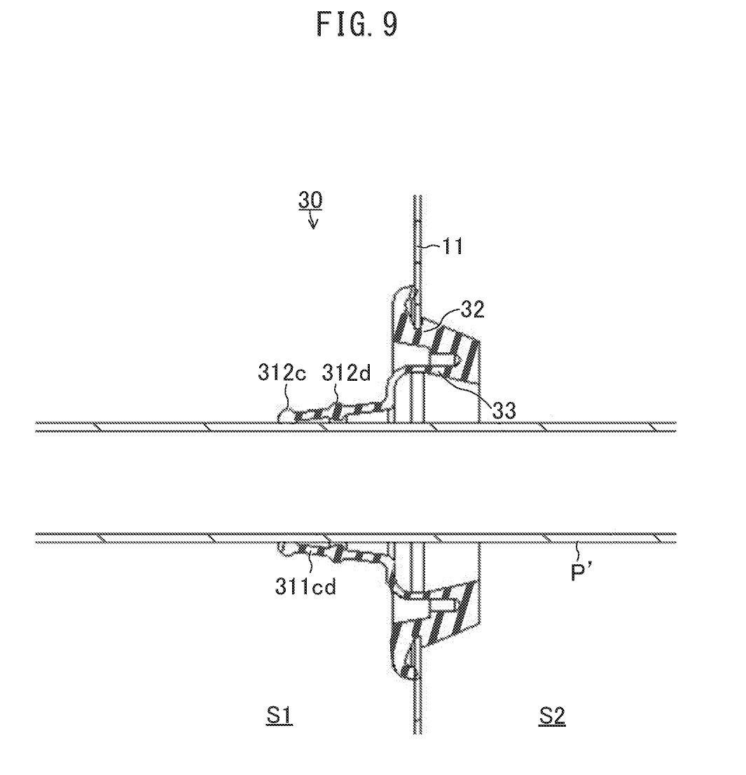

To correspond to the refrigeration piping P′ which is thicker than the refrigeration piping P illustrated in FIG. 4, FIGS. 8 and 9 illustrate a mode of use of the rubber body 30 for closure in which the tapered tubular portion 311 is cut at the position of the imaginary line LB of FIG. 7.

In addition, the tapered tubular portion 311 may be cut at a position of a line segment X in FIG. 7. The imaginary line LX passes an end of the ring portion 312a on the opposite side of the displacement allowance portion 33 in the piping insertion direction. In this case, as the ring portion 312a is cut and separated, the ring portion 312b presses and contacts the refrigeration piping. However, a portion 311ab of the tapered tubular portion 311 remains, the portion 311ab (hereinafter, referred to as a first middle portion) connecting the ring portion 312a and the ring portion 312b having an increased thickness.

The first intermediate portion 311ab is tubular and extends from the ring portion 312b in the piping insertion direction opposing to the displacement allowance portion 33. The first intermediate portion 311ab can be used as a fastening margin for fastening the refrigeration piping P. The water-tightness between the pressurized insertion receiving portion 31 and the refrigeration piping P can be increased by fastening the fastening margin.

Similarly, when the tapered tubular portion 311 is cut at a position of a line segment Y, a connection portion 311bc connecting the ring portion 312b and the ring portion 312c (hereinafter, referred to as a second middle portion) of the tapered tubular portion 311 can be used as a fastening margin. In addition, when the tapered tubular portion 311 is cut at a position of the imaginary line LZ, a connection portion 311cd of the tapered tubular portion 311 that connects the ring portion 312c having an increased thickness and the ring portion 312d (hereinafter, referred to as a third middle portion) can be used as a fastening margin.

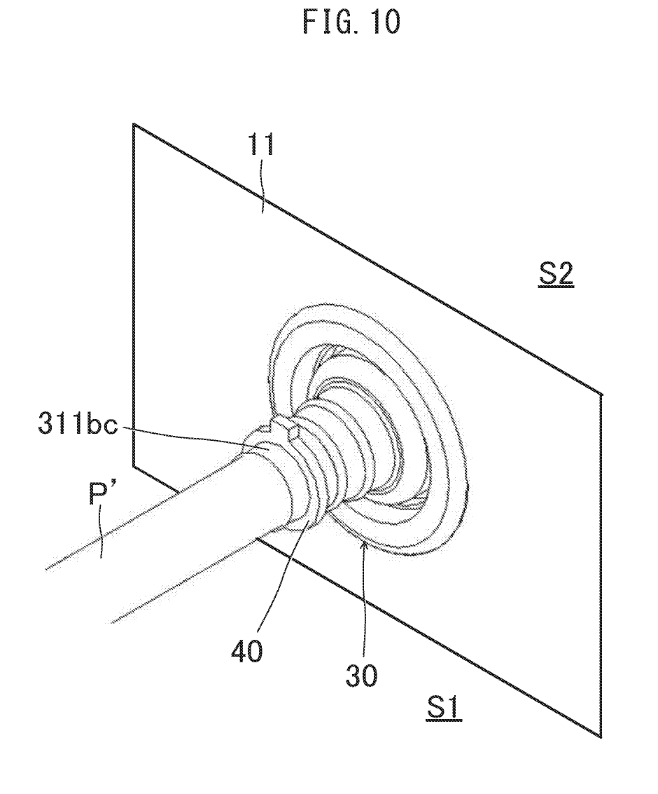

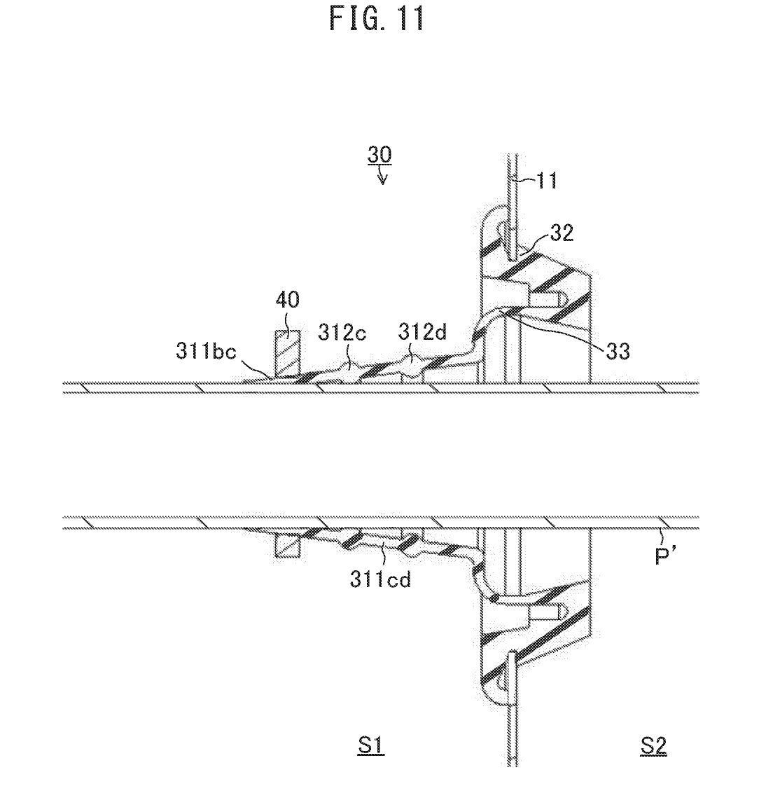

FIGS. 10 and 11 illustrate a mode of use of the rubber body 30 for closure in which the tapered tubular portion 311 is cut at a position of the imaginary line LY of FIG. 7. The ring portion 312c presses and contacts the refrigeration piping P′, and the second intermediate portion 311bc is fastened to the refrigeration piping P′ by a fastening tool 40. In this way, water-tightness can be acquired not only between the ring portion 312c and the refrigeration piping P′ but also between the second intermediate part between 311bc and the refrigeration piping P′ can be acquired. Thus, water-tightness can be acquired between the pressurized insertion receiving portion 31 and the refrigeration piping P′.

A resin cable tie can be used for the fastening tool 40. The fastening tool 40 may be a material that can fasten the fastening margin covering the refrigeration piping, and is not limited to the cable tie in particular.

As mentioned above, the rubber body 30 for closure can be used by cutting the tapered tubular portion 311 as necessary to be able to select a ring portion that corresponds to the outer diameter of the refrigeration piping among a plurality of ring portions 312a through 312d having different inner diameters. For this reason, a single rubber body 30 for closure can be used in common for the refrigeration piping having different outer diameters, and there is no requirement for a process of selection of a member according to the outer diameter of the refrigeration piping. This also contributes to improvement in efficiency of the manufacturing of the air conditioning device 100 for vehicles illustrated in FIG. 14.

One embodiment of the present disclosure is described above. The present disclosure is not limited to this embodiment, and, for example, following modifications are possible.

(1) In the above mentioned embodiment, the rubber body 30 for closure closes the gap between the refrigeration piping P and the partition plate 11. However, the rubber body 30 for closure also can close a gap between the partition plate 11 and a shaft other than the shaft of the refrigeration piping P. As the shaft other than the shaft of the refrigeration piping P, for example, wiring, a beam, and piping for passage of a fluid other than the refrigerant can be listed.

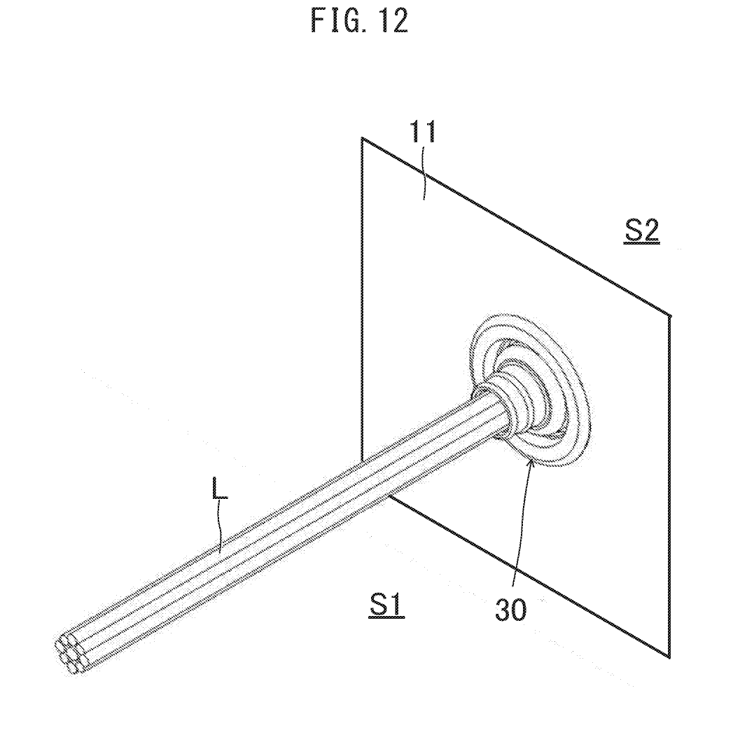

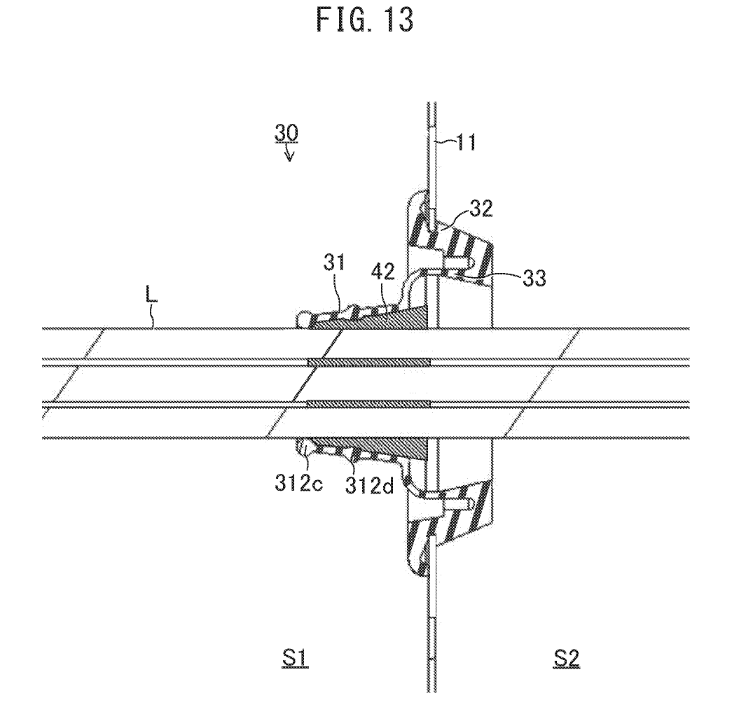

As illustrated in FIGS. 12 and 13, the rubber body 30 for closure can close the gap between the partition plate 11 and a wiring group L formed by bundling up a plurality of wires. In this case, as illustrated in FIG. 13, the water-tightness between the wiring group L and the partition plate 11 can be secured by interposing a filler 42 between the pressurized insertion receiving portion 31 and wiring group L and between the wires forming the wiring group L.

The filler 42 is a cured paste-like sealing material. As the sealing material, for example, a paste-like resin such as a silicone type or a urethane type can be used. The filler 42 is a paste-like material, and thus the filler 42 can be coated on the external peripheral surface of the wiring group L and can press fit between the wires. However, the filler 42 is not particularly limited as long as water-tightness is provided.

(2) The above-mentioned embodiment describes the pressurized insertion receiving portion 31 in a non-disconnected state including the four ring portions 312a-312d. However, the number of the ring portions included in the pressurized insertion receiving portion 31 is not particularly limited, and the number may be two, three, or five or more. In addition, the pressurized insertion receiving portion 31 may have a configuration in which the pressurized insertion receiving portion 31 includes only a single ring portion when the outer diameters of the refrigeration piping P are made uniform in the air conditioning device 100 for vehicles (refer to FIG. 14).

In addition, the pressurized insertion receiving portion 31 does not necessarily include ring portions 312a-312d. Even when the pressurized insertion receiving portion 31 includes only the tapered tubular portion 311, the tapered tubular portion 311 tapers with distance from the displacement allowance portion 33. Thus, the tapered tubular portion 311 can be used by cutting off at a position in which the inner diameter of the tapered tubular portion 311 corresponds to the outer diameter of the refrigeration piping.

In addition, the above-mentioned embodiment describes a configuration in which the tapered tubular portion 311 is continually tapered. However, the tapered tubular portion 311 may have a configuration in which the tapered tubular portion 311 is tapered in stages as the tapered tubular portion 311 goes away from the displacement allowance portion 33. Even in this case, the tapered tubular portion 311 can be used by cutting off at a position at which the inner diameter of the tapered tubular portion 311 corresponds to the outer diameter of the refrigeration piping.

(3) In the above-mentioned embodiment, the elastic body 30 for closure is used to achieve water-tightness. The elastic body 30 for closure closely contacts the peripheral edge portion of the through-hole 11a in the partition plate 11 and, as a shaft, the refrigeration piping P. Thus, the elastic body 30 for closure can be liquid-tight not only for water such as rainwater, condensation water and the like, but also liquids such as washing liquid, oil and the like. Therefore, the elastic body 30 for closure may be used to keep liquid-tightness relative to a liquid other than water.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2015-236397 filed on Dec. 3, 2015, the entire disclosure of which is incorporated by reference herein.

### INDUSTRIAL APPLICABILITY

The elastic body for closure of the present disclosure can be widely used to close a gap between a partition plate in which a through-hole is formed and a shaft inserted in the through-hole. The air conditioning device of the present disclosure, for example, can be used for air conditioning of a house and a passenger compartment of a railroad vehicle.

### REFERENCE SIGNS LIST

10 Housing
11 Partition plate (plate-like body)
11a Through-hole
12 Base frame
13 Cover
20 Air conditioning device
21, 22 Refrigeration cycle device
23 Outdoor blower
24 Indoor blower
30, 30′ Rubber body for closure (elastic body for closure)
31 Pressurized insertion receiving portion
31a Opening
32 Fitting portion
33 Displacement allowance portion
34, 34′ Lip portion
40 Clamping tool
42 Filler
100 Air conditioning device for cars (air conditioning device)
211, 221 Compressor
212, 222 Outdoor heat exchanger (condenser)
213, 223 Expander
214, 224 Indoor heat exchanger (evaporator)
215, 225 Gas-liquid separator
311 Taper tubular portion
311ab First intermediate portion (fastening margin)
311bc Second intermediate portion (fastening margin)
311cd Third intermediate portion (fastening margin)
312a-312d Ring portion
321 Outer cylinder portion
322 Groove
331 Inner cylinder portion
332 Base
333 Curved portion
S1 Outdoor unit accommodation chamber (accommodation chamber)
S2 Indoor unit accommodation chamber (accommodation chamber)
P, P′ Refrigerant piping (piping, shaft)
L Wiring group

1. An elastic body for closure for closing a gap between a plate-like body in which a through-hole is formed and a shaft that is inserted in the through-hole, comprising:
a pressurized insertion receiving portion having formed therein an opening into which the shaft is pressed and inserted, to elastically press and contact liquid-tightly against an external surface of the shaft that is pressed and inserted in the opening;
a fitting portion to fit liquid-tightly a peripheral edge portion of the through-hole in the plate-like body in a state elastically pressing against an inner circumferential surface of the through-hole; and
a displacement allowance portion to close a gap between the pressurized insertion receiving portion and the fitting portion, and allow a relative displacement of the pressurized insertion receiving portion and the fitting portion in a direction parallel to the plate-like body by elastic deformation,
wherein the fitting portion includes an external cylinder portion fitted in the through-hole;
the displacement allowance portion includes an inner cylinder portion that is disposed inward in a radial direction of the external cylinder portion and a base coupled to the inner cylinder portion and the external cylinder portion; and
a thickness of the inner cylinder portion reduces as the inner cylinder portion increases in distance from the base.

2. The elastic body for closure according to claim 1,
wherein the pressurized insertion receiving portion comprises a tapered tubular portion that: (i) has the opening formed at an end thereof, (ii) forms a tube extending in an insertion direction of the shaft to the through-hole, (iii) tapers continuously or in a stepwise manner as the pressurized insertion receiving portion goes away from the displacement allowance portion, and (iv) is disconnectable along a surface orthogonal to the insertion direction.

3. The elastic body for closure according to claim 1, wherein the pressurized insertion receiving portion comprising:
a ring portion that is annularly thickened, to contact by pressing liquid-tightly against the external surface of the shaft; and
a fastening margin that forms a tube extending in a direction opposite to the displacement allowance portion with respect to the insertion direction of the shaft to the through-hole from the ring portion, and is fastenable to the external surface of the shaft.

4. The elastic body for closure according to claim 1, further comprising a lip portion that outwardly extends from the fitting portion in a radial direction of the through-hole, to elastically contact the plate-like body.

5. The elastic body for closure according to claim 4, wherein the lip portion elastically contacts around an entire perimeter of the plate-like body to surround the through-hole.

6. The elastic body for closure according to claim 1, wherein the shaft includes at least one of piping or wiring.

7. An air conditioning device, comprising:
a housing defining an internal space therein;
a plate-like body partitioning the internal space of the housing into at least two accommodation chambers, and including a through-hole formed therein that communicates between one accommodation chamber and another adjacent accommodation chamber;
a refrigeration cycle device including a condenser disposed in the one accommodation chamber, an evaporator disposed in the another accommodation chamber, and a shaft inserted through the through-hole; and
an elastic body for closure including:
(a) a pressurized insertion receiving portion having formed therein an opening into which the shaft is pressed and inserted, to elastically press and contact liquid-tightly against an external surface of the shaft that is pressed and inserted in the opening;
(b) a fitting portion to fit liquid-tightly a peripheral edge portion of the through-hole in the plate-like body in a state elastically pressing against an inner circumferential surface of the through-hole; and
(c) a displacement allowance portion to close a gap between the pressurized insertion receiving portion and the fitting portion, and allow a relative displacement of the pressurized insertion receiving portion and the fitting portion in a direction parallel to the plate-like body by elastic deformation,
wherein the fitting portion includes an external cylinder portion fitted in the through-hole;
the displacement allowance portion includes an inner cylinder portion that is disposed inward in a radial direction of the external cylinder portion and a base coupled to the inner cylinder portion and the external cylinder portion; and
a thickness of the inner cylinder portion reduces as the inner cylinder portion increases in distance from the base.

8. The air conditioning device according to claim 7, further comprising a fastening tool to fasten to the shaft the pressurized insertion receiving portion in a state in which the shaft is pressed and inserted.

9. A closure method for closing a gap between a plate-like body in which a through-hole is formed and a shaft that is inserted in the through-hole, comprising:
pressuring and inserting the shaft into an opening of an elastic body for closure, and elastically pressing and contacting a pressurized insertion receiving portion liquid-tightly against an external surface of the shaft, the elastic body for closure including:
the pressurized insertion receiving portion having formed therein the opening;
a fitting portion to fit a peripheral edge portion of the through-hole in the plate-like body; and
a displacement allowance portion to close a gap between the pressurized insertion receiving portion and the fitting portion, and allow a relative displacement of the pressurized insertion receiving portion and the fitting portion by elastic deformation; and
pushing the fitting portion into the through-hole, and fitting the fitting portion against the peripheral edge portion of the through-hole in a state elastically pressing against an inner circumferential surface of the through-hole,
wherein the fitting portion includes an external cylinder portion fitted in the through-hole;
the displacement allowance portion includes an inner cylinder portion that is disposed inward in a radial direction of the external cylinder portion and a base coupled to the inner cylinder portion and the external cylinder portion; and
a thickness of the inner cylinder portion reduces as the inner cylinder portion increases in distance from the base.
